(19) United States
(12) Patent Application Publication
(10) Pub. No.: US 2019/0349663 A1
(43) Pub. Date: Nov. 14, 2019

(54) SYSTEM INTERACTING WITH SMART AUDIO DEVICE

(71) Applicant: Tymphany Acoustic Technology (Huizhou) Co., Ltd., Huizhou City (CN)

(72) Inventor: ZHIWEN CHEN, Huizhou City (CN)

(21) Appl. No.: 16/406,864

(22) Filed: May 8, 2019

(30) Foreign Application Priority Data
May 9, 2018 (CN) 201810437174.2

(51) Int. Cl. H04R 1/10; G06F 3/16; G06F 3/0489; H04W 4/80; G10L 15/00; G06F 3/01; G06F 3/0488

(52) U.S. Cl. CPC H04R 1/1041; G06F 3/167; G06F 3/0489; H04W 4/80; H04R 2430/01; G06F 3/017; G06F 3/011; G06F 3/04883; H04R 2420/07; G10L 15/005

(57) ABSTRACT

A system includes a wearable device and a smart audio device, the wearable device including a Bluetooth module, a language acquisition module, and a motion sensor. The wearable device is paired with the smart audio device through the Bluetooth module, the language acquisition module is configured to acquire language information of a user, and the motion sensor is configured to identify a specific gesture action of the user. In use, the wearable device interacts with the smart audio device through the language acquisition module and the motion sensor. By pairing with the wearable device, the smart audio device only receives a wake-up command of the wearable device, which improves the accurate wake-up rate of the smart audio device and avoids false wake-up. The ability to perform long-distance interaction and anti-noise interference is enhanced, and the user may not have to speak a command loudly to ensure a good user experience.

### CROSS REFERENCE TO RELATED APPLICATIONS

This application claims priority under 35 U.S.C. § 119 to Chinese Patent Application No. CN 201810437174.2, which was filed on May 9, 2018, and which is herein incorporated by reference.

### TECHNICAL FIELD

The present invention relates to a system, in particular, to a system interacting with smart audio.

### BACKGROUND

As a kind of music equipment, the smart audio device plays an increasingly important role in the life of modern people with the development of economy. It has become an indispensable home appliance. In order to be able to understand human commands, the smart audio device must be equipped with a microphone on it to pick up the external language signal. In order to be able to receive external language instructions 360 degrees in an all-round way, the current common method in the industry is to use the microphone array technology. The microphone array has better ability to suppress noise and speech enhancement, and does not require the microphone to be always used in the direction of the sound source. How to wake up the smart audio device that is playing music: usually, the user is required to increase the volume of the speech, so that the volume of the wake-up command is sufficiently large, and it is possible to be recognized by the smart audio after being greater than the background noise. However, requiring the user to shout a wake-up command will bring an unpleasant user experience.

The audio will also cause a certain box vibration when playing at high volumes, so the smart audio device requires a certain noise reduction and shock absorption design to improve the efficiency of wake-up. In the family environment, sometimes there are particularly noisy situations, and the speech content is also uncertain. For example, when watching TV, as various dialogues will appear on the TV, the smart audio will be easily wake-up by mistake, and then perform various strange conversations or wrong operations, such as opening the air conditioner, leading to a very bad and terrible user experience.

The volume of the sound is inversely proportional to the square of the distance, so the farther the distance is, the harder waking up the smart audio and performing language interaction is. At present, smart audio devices on the market generally only extend the language interaction distance to within 3 meters, and operate in a relatively quiet environment, let alone interact 5 meters away.

The microphone is mounted on the smart audio device, and the smart speaker is usually fixed at a certain position in the home, and the position of the human in the home life is free and arbitrary. This determines the current interactions have certain limitations. However, the smart audio only relies on the wake-up method using a specific vocabulary, and is more likely to be awakened by mistakes, resulting in inconvenience to the user.

### SUMMARY

In order to solve the above problems existing in the prior art, the present invention provides a system interacting with smart audio (i.e., a smart audio capable device).

To achieve the above object, the present invention provides the following technical solution.

A system comprises a wearable device and a smart audio device, the wearable device including a Bluetooth module, a language acquisition module, and a motion sensor. The wearable device is paired with the smart audio device through the Bluetooth module, the language acquisition module is configured to acquire language information of a user, and the motion sensor is configured to identify a specific gesture action of the user. In use, the wearable device interacts with the smart audio device through the language acquisition module and the motion sensor.

Further, the interaction is that the user wears the wearable device and interacts with the smart audio device using a combination of specific vocabulary and action gestures.

Further, the interaction is that the smart audio device answers questions through commands of the wearable device.

Further, the interaction is that the smart audio device answers questions or plays a volume of the music by monitoring a distance adjustment with the wearable device.

Further, the wearable device further includes a button module, and an input and display module, which are respectively communicatively connected with the smart audio device, the user controlling the closing of the smart audio device through the button module so as to solve the problem that when the language acquisition module fails, the user may only go to the smart audio device to unplug the power or turn off the switch to stop the smart audio device; the user sends a handwritten input text command to the smart audio device through the input and display module, the handwritten input text command taking precedence over a command of the language acquisition module, and the smart audio device preferentially feeds back the handwritten input text command.

Further, the smart audio device sends a message to the wearable device through the input and display module to ensure the privacy and storability of the message.

Further, the wearable device further includes an audio output module, and the audio output module may be an earphone interface for connecting an earphone, so that the music of the smart audio device is transmitted to the wearable device, and then transmitted to the user through the earphone.

Further, the system further comprises a Bluetooth earphone, and the Bluetooth earphone is communicatively connected to the Bluetooth module to transmit the music of the smart audio device to the wearable device, and then transmit to the user through the Bluetooth earphone.

Further, the wearable device further includes a fingerprint identification module, the fingerprint identification module being communicatively connected to the smart audio device, and the fingerprint identification module may identify a user identity and set a user priority.

Further, the wearable device is a sports bracelet.

Further, the language acquisition module is a microphone.

Based on the above technical solutions, the technical effects obtained by the present invention are:

1. By pairing with the wearable device, the smart audio device only receives a wake-up command of the wearable device, which improves the accurate wake-up rate of the smart audio device and avoids false wake-up;

2. The system may perform long-distance interaction, give full play to the artificial intelligence function that the smart audio device may hear and receive user commands, and realize interaction well during use. By sending commands to a close-range microphone and then transmitting commands over long distances via Bluetooth, the remote smart audio device responds, and the anti-noise ability is greatly enhanced. At the same time, the user does not have to speak loudly, thereby ensuring a good user experience.

### BRIEF DESCRIPTION OF THE DRAWINGS

FIG. 1 is a view of a system interacting with smart audio according to the present invention.

FIG. 2 is a view of a usage scenario of a system interacting with smart audio according to the present invention.

FIG. 3 is a view of a wearable device expansion module of a system interacting with smart audio according to the present invention.

Among those, the reference numerals are as follows:

1 wearable device

2 smart audio device

11 Bluetooth module

12 language acquisition module

13 motion sensor

### DETAILED DESCRIPTION

In order to facilitate the understanding of the present invention, the present invention will be described more fully hereinafter with reference to the accompanying drawings and specific embodiments. Preferred embodiments of the present invention are shown in the drawings. However, the present invention may be embodied in many different forms and is not limited to the embodiments described herein. Rather, these embodiments are provided so that this disclosure of the present invention will be more fully understood.

It should be noted that when an element is referred to as being “fixed” to another element, it can be directly on the other element or a center element can be present. When an element is referred to as being “connected” to another element, it can be directly connected to the other element or a center element can be present simultaneously.

For ease of reading, the terms “upper”, “lower”, “left”, and “right” are used herein in the drawings to indicate the relative position of the reference between the elements, and not to limit the application.

All technical and scientific terms used herein, unless otherwise defined, have the same meaning as commonly understood by one of ordinary skill in the art to the present invention. The terminology used in the description of the present invention is for the purpose of describing particular embodiments and is not intended to limit the present invention.

### Embodiment 1

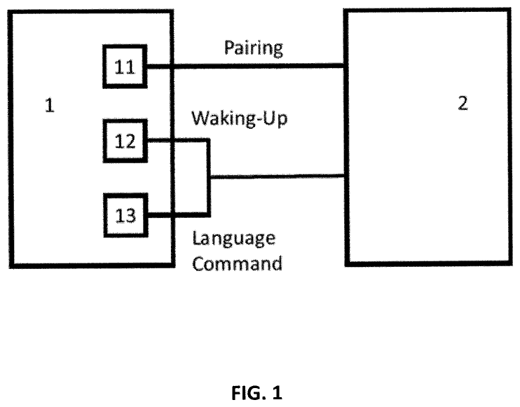

FIG. 1 is a view of a system interacting with smart audio. The system includes a wearable device 1 and a smart audio device 2. The smart audio device may be, for example, a speaker. The wearable device 1 includes a Bluetooth module 11, a language acquisition module 12, and a motion sensor 13. The language acquisition module 12 is configured to acquire language information of a user. The motion sensor 13 is configured to identify a specific gesture action of the user. The wearable device 1 is paired with the smart audio device 2 through the Bluetooth module 11, so that the smart audio device 2 may only receive a wake-up command of the wearable device by pairing with the wearable device, thereby improving the accurate wake-up rate of the smart audio and avoiding false wake-up.

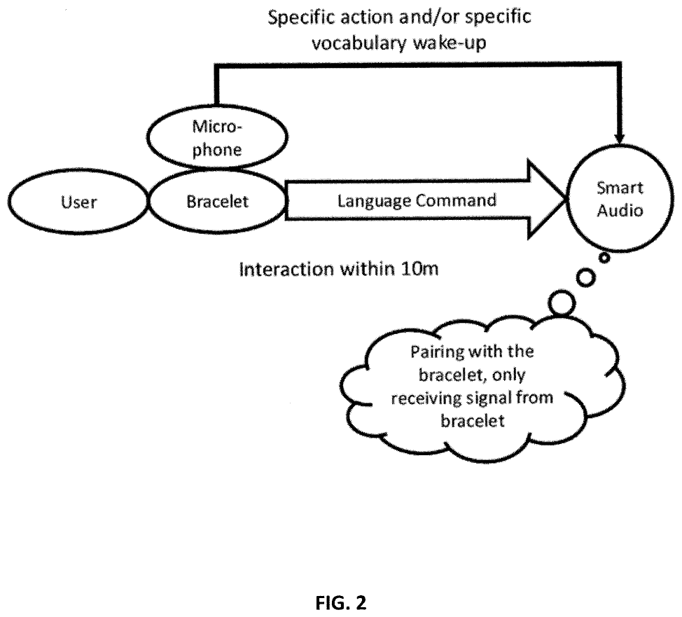

FIG. 2 is a view of a usage scenario of a system interacting with smart audio according to the present embodiment. The wearable device 1 may specifically be a wearable device with Bluetooth or other wireless transmission functions and motion sensors in the prior art, including a sports bracelet, a smart watch, and the like. In the present embodiment, the wearable device 1 is a sports bracelet, and the language acquisition module 12 is a microphone. That is, the sports bracelet includes a motion sensor, a microphone, and Bluetooth. Since the sports bracelet is worn on the user's wrist at any time, the distance from the wrist to the sound source (mouth) is always within 1 m. When in use, the sports bracelet and the smart audio device are paired in advance through Bluetooth, and the smart audio device only receives the wake-up and other commands of the sports bracelet, then at a distance of less than 10 m from the smart audio, the user adopts an accurate and efficient wake-up method of “specific vocabulary and action gestures”, such as “Hi Alexa”+“hands-up action”, to wake up the smart audio. Since the motion sensor on the sports bracelet detects the acceleration, it is easy to recognize the action of lifting the wrist, and the LCD screen lights up. When a specific vocabulary “Hi Alexa” is picked up by the microphone on the bracelet, a simple algorithm allows the bracelet to recognize that this is a wake-up command, so that the smart audio device paired with the sports bracelet only receives wake-up and other commands from the sports bracelet. At that time, the interaction between the sports bracelet and the smart audio becomes the user talking with the sports bracelet, and then the remote smart audio answers questions after receiving the commands.

The actual use scenario may also be: the smart audio device may realize the interaction between the sports bracelet and the smart audio device by adjusting the answer to the question or the loudness of the played music through monitoring the distance to the sports bracelet (i.e. the distance from the user).

### Embodiment 2

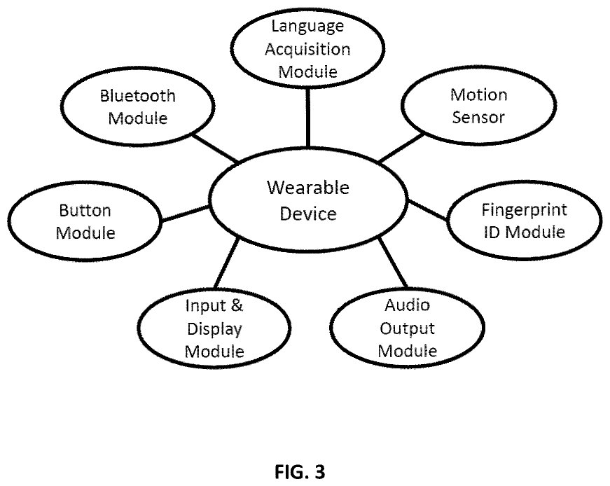

FIG. 3 is a view of a wearable device expansion module of a system interacting with smart audio according to the present invention. The wearable device 1 further includes a button module, and an input and display module. Specifically, the button module is a button, the input and display module is a touch display screen, and the touch display screen and the button are respectively connected to the smart audio device 2. When the smart audio device is playing loud music, or the background music is noisy, the language acquisition module on the wearable device may fail to operate, and may not accurately capture the user's language command in time, then there may be an embarrassing situation in which the user has to repeatedly yell out commands.

The user may control the closing of the paired smart audio device by pressing and holding the button for more than three seconds, so that the smart audio device stops all ongoing operations (such as playing music) and resumes to the quiet state of waiting for the commands. This avoids the problem that when the language acquisition module fails to operate, the user may only go to the smart audio to unplug the power or turn off the switch to stop the smart audio.

When the user's throat is uncomfortable one day, or for some people with language barriers, the user may enter the text command by hand touching the display to send it to the smart audio for interaction. The user may also set the handwritten input text command to have a higher priority than the command of the language acquisition module and the smart audio may preferentially feedback the handwritten input text command.

When the user does not want the smart audio to broadcast the message through the language, the user may have the smart audio send the message to the touch display screen on the wearable device, allowing the user to read the message and save the message up close. For example, when the user lets the smart audio device query the weather forecast for the next few days without expecting the language broadcast of the smart audio to affect other family members, or when the hearing impaired person uses the smart audio device, this kind of interaction may ensure the privacy and storability of the message, and the user may read the previously queried message at any time while on the go.

### Embodiment 3

FIG. 3 is a view of a wearable device expansion module of a system interacting with smart audio according to the present invention. The wearable device 1 further includes an audio output module, and the audio output module may be an earphone interface for connecting an earphone. When the user wants to listen to music and does not want to bother with other family members, the smart audio device may be used to search from the network for personally interested music to be transmitted to the wearable device, then the user may enjoy music exclusively by setting an earphone interface on the wearable device 1 and connecting the earphone, or connecting to the wearable device 1 through the Bluetooth earphone.

### Embodiment 4

FIG. 3 is a view of a wearable device expansion module of a system interacting with smart audio according to the present invention. The wearable device 1 further includes a fingerprint identification module, the fingerprint identification module being communicatively connected to the smart audio device 2, and the fingerprint identification module may help the smart audio device 2 accurately identify the identity of the user. When a number of family members use the smart audio device 2, the priority of different family member commands may be set. When a plurality of people interact with the smart audio device 2 simultaneously, the fingerprint identification module may ensure that the smart audio device 2 clearly distinguishes the owner's identity and processes the commands according to the priority. For example, the adult's commands will take precedence over children's commands. When the commands conflict with each other, the adult's commands will prevail. For example, a child wants to turn on the TV through a smart audio, but the adult has a higher priority command to turn off the TV.

In the technical solution of the present invention, by removing the language acquisition module, i.e., the microphone, from the smart audio and adding the microphone to the sports bracelet, the user may adjust the distance between the sports bracelet (i.e., the microphone) and the human mouth to easily realize that the language command is accurately recognized even when the ambient noise is relatively large. Since the volume of the sound is inversely proportional to the square of the distance, the user does not have to yell out commands, thereby realizing long-range efficient and accurate wake-up and language controlling for the smart audio, so that the anti-noise ability is greatly enhanced, and a pleasant user experience may be obtained.

By arranging a Bluetooth module, a language acquisition module, a motion sensor, a button module, an input and display module, an audio output module, a fingerprint identification module, and the like on the wearable device, the interaction between the wearable device and the smart audio is not limited to the way the user only uses the language command and the smart audio only broadcasts through the language. In this way, the smart audio is greatly caused to function as the role of the central control center of the smart home, and the smart audio is more and more like the role of a family manager. At the same time, the operation process is highly smart and a variety of interactions between users and smart audio may be achieved well.

The above is only an example and description of the structure of the present invention, and the description thereof is more specific and detailed, but is not to be construed as limiting the scope of the present invention. It should be noted that a number of variations and modifications may be made by those skilled in the art without departing from the spirit and scope of the present invention. These obvious alternatives are within the scope of protection of the present invention.

1. A system, comprising:
a wearable device, the wearable device comprising:
a Bluetooth module;
a language acquisition module; and
a motion sensor; and
a smart audio device,
wherein the wearable device is paired with the smart audio device through the Bluetooth module,
wherein the language acquisition module and the motion sensor are respectively communicatively connected to the smart audio device,
wherein the language acquisition module is configured to acquire language information of a user,
wherein the motion sensor is configured to identify a specific gesture action of the user, and
wherein, in use, the wearable device interacts with the smart audio device through the language acquisition module and the motion sensor.

2. The system interacting with smart audio according to claim 1, wherein the user wears the wearable device and interacts with the smart audio device using a combination of specific vocabulary and action gestures.

3. The system interacting with smart audio according to claim 1, wherein the smart audio answers questions through commands of the wearable device.

4. The system interacting with smart audio according to claim 1, wherein the smart audio device answers questions or plays a loudness of the music by monitoring a distance adjustment with the wearable device.

5. The system interacting with smart audio according to claim 1, wherein the wearable device further comprises:
a button module connected with the smart audio device; and
an input and display module connected with the smart audio device,
wherein the user controls the closing of the smart audio device through the button module, and
wherein the user sends a handwritten input text command to the smart audio device through the input and display module, the handwritten input text command taking precedence over a command of the language acquisition module, and the smart audio device preferentially feeds back the handwritten input text command.

6. The system interacting with smart audio according to claim 5, wherein the smart audio device sends a message to the wearable device through the input and display module.

7. The system interacting with smart audio according to claim 5, wherein the wearable device further comprises an audio output module.

8. The system interacting with smart audio according to claim 7, wherein the audio output module comprises an earphone interface for connecting an earphone.

9. The system interacting with smart audio according to claim 5, further comprising a Bluetooth earphone communicatively connected to the Bluetooth module.

10. The system interacting with smart audio according to claim 1, wherein the wearable device further comprises a fingerprint identification module communicatively connected to the smart audio device, and the fingerprint identification module being configured to identify a user identity and set a user priority.

11. The system interacting with smart audio according to claim 1, wherein the wearable device is a sports bracelet, and the language acquisition module is a microphone.
